(19) United States
(12) Patent Application Publication
(10) Pub. No.: US 2015/0212621 A1
(43) Pub. Date: Jul. 30, 2015

(54) TOUCH PANEL CONTROLLING METHOD AND SYSTEM

(71) Applicant: INDUSTRIAL TECHNOLOGY RESEARCH INSTITUTE, Hsinchu (TW)

(72) Inventors: Yen-Lin PAN, Kaohsiung City (TW); Heng-Yin CHEN, Hsinchu County (TW); Po-Wei LIN, Kaohsiung City (TW)

(73) Assignee: INDUSTRIAL TECHNOLOGY RESEARCH INSTITUTE, Hsinchu (TW)

(21) Appl. No.: 14/317,923

(22) Filed: Jun. 27, 2014

(30) Foreign Application Priority Data
Jan. 24, 2014 (TW) 103102674

(51) Int. Cl. G06F 3/044

(52) U.S. Cl. CPC G06F 3/044

(57) ABSTRACT

A system and a method for controlling a touch panel are provided. The method for controlling the touch panel includes the following steps. An induction parameter of the touch panel is provided. An induction signal is received by the sensing unit. Whether the induction signal is a touch signal is determined. If the induction signal is not the touch signal, then whether a physical characteristic of the touch panel is changed is determined. If the physical characteristic of the touch panel is changed, then the system adjusts the induction parameter of an induction region affected by the induction signal.

This application claims the benefit of Taiwan application Serial No. 103102674, filed Jan. 24, 2014, the subject matter of which is incorporated herein by reference.

### TECHNICAL FIELD

The disclosure relates in general to a touch panel controlling method and a touch panel controlling system.

### BACKGROUND

Touch panel has become a new information input device in recent years. The principle of touch panel is operated by touching the screen. Touch panel is conveniently carrying and human-based function operation. In various kinds of display, the flexible or foldable display can be bent for easily carrying and accommodating. Therefore, the flexible or foldable display has become one of the important aspects of display technology. However, it is easy to cause noises on the bending parts of the touch panel, while the user repeatedly bends the display. Those noises will result a lot of error touch points which are unnecessary.

### SUMMARY

The disclosure is related to a touch panel controlling method and a touch panel controlling system. Whether an induction signal received by a touch panel is a touch signal and whether the touch panel is bent are determined. An induction parameter of an induction region affected by the induction signal is adjusted. Noises which are caused by bending a flexible display can be filtered and the operation accuracy can be improved while a user operates the touch panel.

According to an aspect the disclosure, a touch panel controlling system including a storage unit, a sensing unit, a first determining unit, a second determining unit, and an adjusting unit is provided. The storage unit stores an induction parameter of a touch panel. The sensing unit receives an induction signal. The first determining unit determines whether the induction signal is a touch signal. The second determining unit determines whether a physical characteristic of the touch panel is changed if the induction signal is not the touch signal. The adjusting unit adjusts the induction parameter of an induction region affected by the induction signal, if the physical characteristic of the touch panel is changed and the induction signal is not the touch signal.

According to another aspect of the disclosure, a touch panel controlling method is provided. The touch panel controlling method includes the following steps. An induction parameter of a touch panel is provided. An induction signal is received by a sensing unit. Whether the induction signal is a touch signal is determined. If the induction signal is not the touch signal, whether a physical characteristic of the touch panel is changed is determined. If the physical characteristic of the touch panel is changed, the induction parameter of an induction region affected by the induction signal is adjusted.

The above and other aspects of the disclosure will become better understood with regard to the following detailed description of the preferred but non-limiting embodiments. The following description is made with reference to the accompanying drawings.

### BRIEF DESCRIPTION OF THE DRAWINGS

FIGS. 1A to 1B are a block diagram of a touch panel controlling system according to a first embodiment.

FIG. 2 is a flowchart of a touch panel controlling method according to the first embodiment.

FIG. 3 is a detailed flowchart of the step S230 according to the first embodiment.

FIGS. 4A to 4E are a schematic diagram of the changing of the physical characteristic of the touch panel according to the first embodiment.

FIG. 5 is a block diagram of a touch panel controlling system according to a second embodiment.

FIG. 6 is a schematic diagram of a bending way of a touch panel according to a third embodiment.

FIG. 7 is a flowchart diagram of a touch panel controlling method according to a fourth embodiment.

### DETAILED DESCRIPTION

### First Embodiment

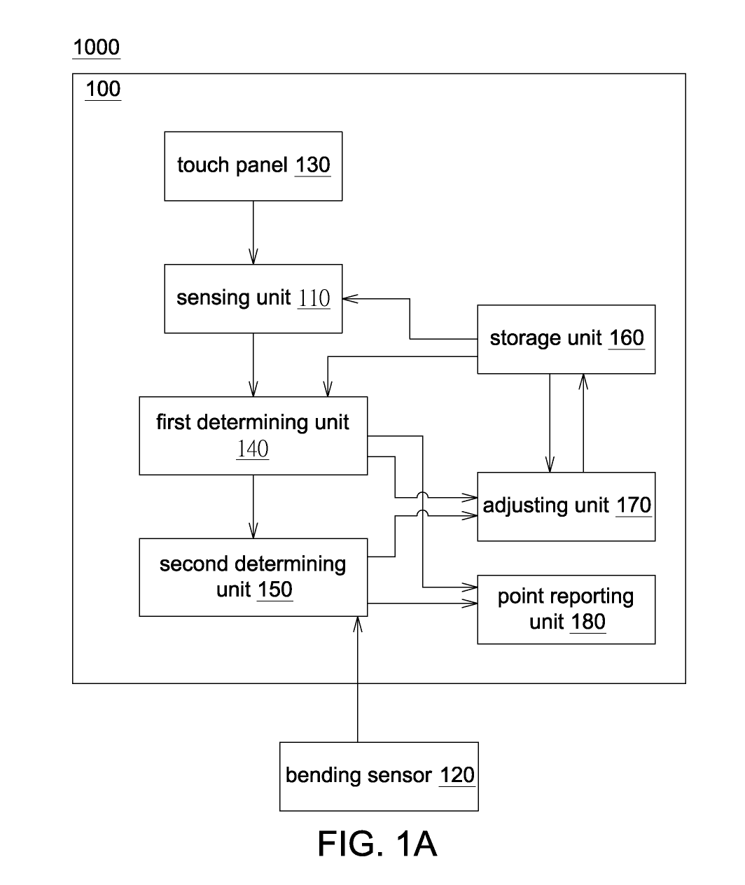

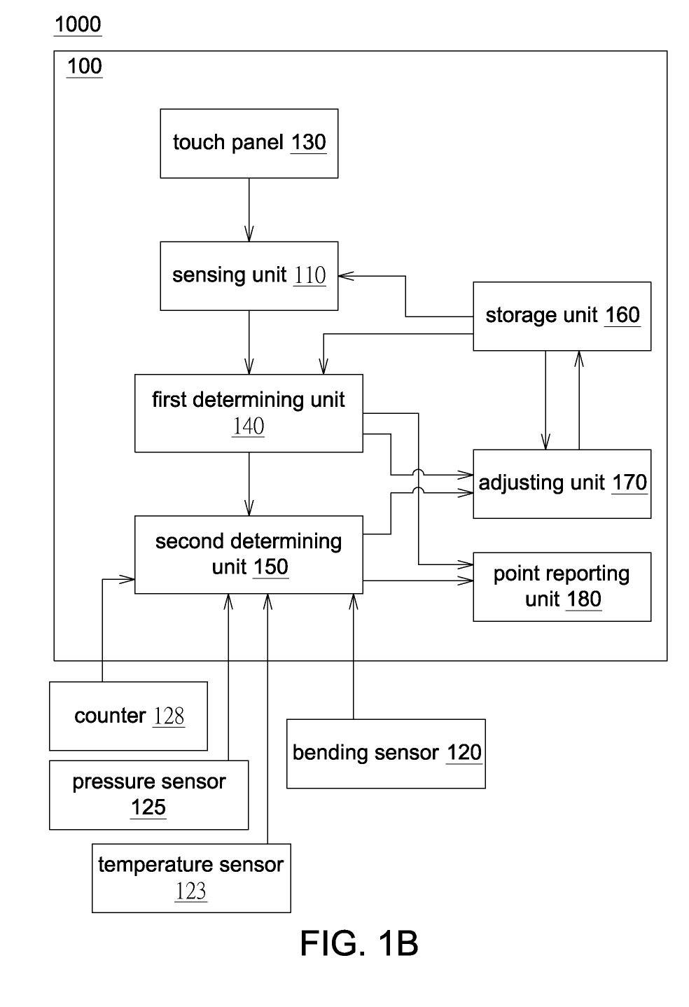

FIGS. 1A to 1B are a block diagram of a touch panel controlling system 1000 according to a first embodiment of the present disclosure. Referring to FIG. 1A, the touch panel controlling system 1000 comprises a touch module 100 and a bending sensor 120. The bending sensor 120 is used for determining whether a touch panel 130 is bent.

Besides, the touch module 100 comprises the touch panel 130, a sensing unit 110, a first determining unit 140, a second determining unit 150, a storage unit 160, an adjusting unit 170, and a point reporting unit 180. The touch panel 130 receives a touch signal inputted from a user. For example, the touch panel 130 can be a capacitive touch panel, a resistive touch panel, a sonic type touch panel or an optical type touch panel and which consists of touch controlling circuits. The touch panel 130 is connected to the sensing unit 110. For example, each of the sensing unit 110, the first determining unit 140, the second determining unit 150, the storage unit 160, the adjusting unit 170 and the point reporting unit 180 can be a flexible printed circuit board or a printed circuit board which is connected to the touch panel 130. The sensing unit 110 is connected to the touch panel 130 to receive the signal outputted from the touch panel 130. The first determining unit 140 and the second determining unit 150 are used for performing various kinds of determining procedures. The first determining unit 140 is connected to the sensing unit 110, the second determining unit 150, the adjusting unit 170 and point reporting unit 180. The second determining unit 150 is connected to the adjusting unit 170 and the point reporting unit 180. In one embodiment, the second determining unit 150 can be connected to the bending sensor 120. The storage unit 160 is used for storing information. For example, the storage unit 160 can be a memory, a disk, or a memory card, etc., which can be used to store the information. The storage unit 160 can be a storage device accessed by a remote connection. The storage unit 160 is connected to the adjusting unit 170, the sensing unit 110, and the first determining unit 140. The adjusting unit 170 is used for adjusting the touch panel 130. The point reporting unit 180 is used for performing a touch point reporting procedure. The touch point reporting procedure includes the steps of showing the touch points on a display, performing a calculation on the touch point or sending a point reporting signal, etc., which is not limited thereto. For instance, each of the sensing unit 110, the first determining unit 140, the second determining unit 150, the adjusting unit 170 and the point reporting unit 180 can be a micro chip, a firmware circuitry or a storage media which stores a plurality of program codes.

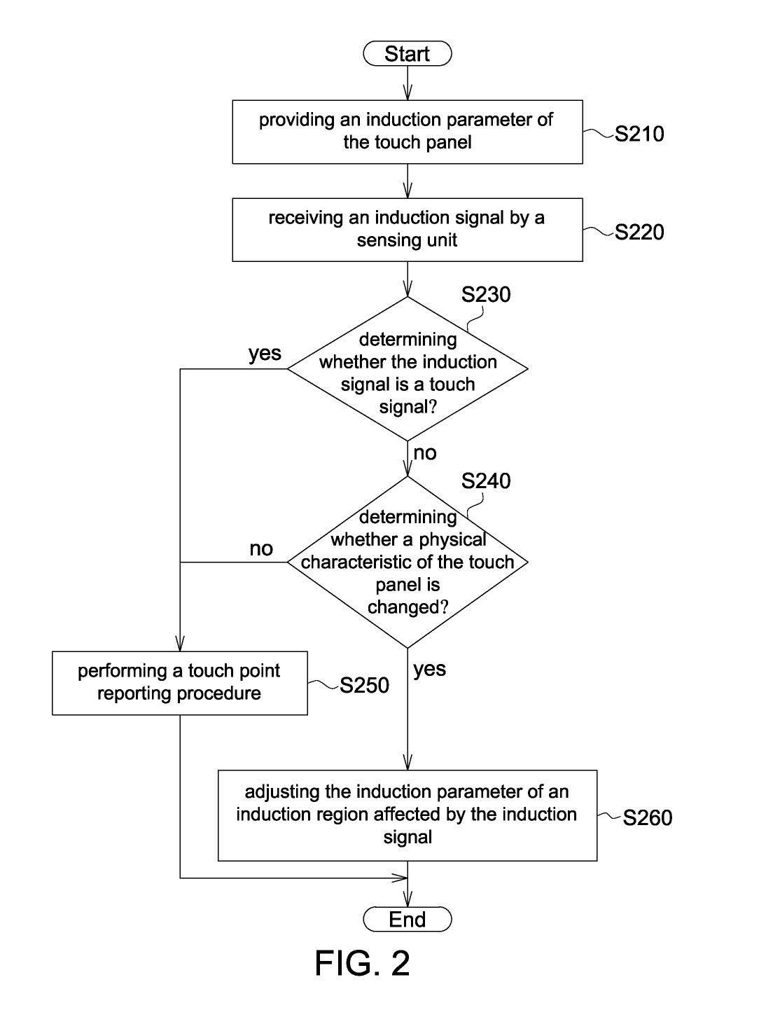

FIG. 2 is a flowchart diagram of a touch panel controlling method according to the first embodiment. The operations between above components and the touch panel controlling method of the embodiment will become better understood with regard to the following detailed flowchart diagram. However, the skilled person should understand that the touch panel controlling method in this embodiment is not limited to be applied to the touch module 100 shown in FIGS. 1A to 1B and is not limited by the sequence of steps shown on the flowchart diagram.

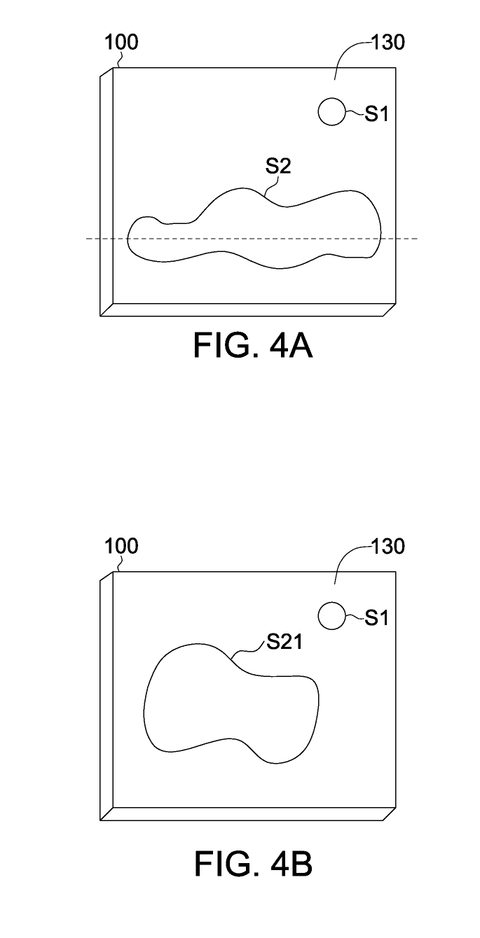

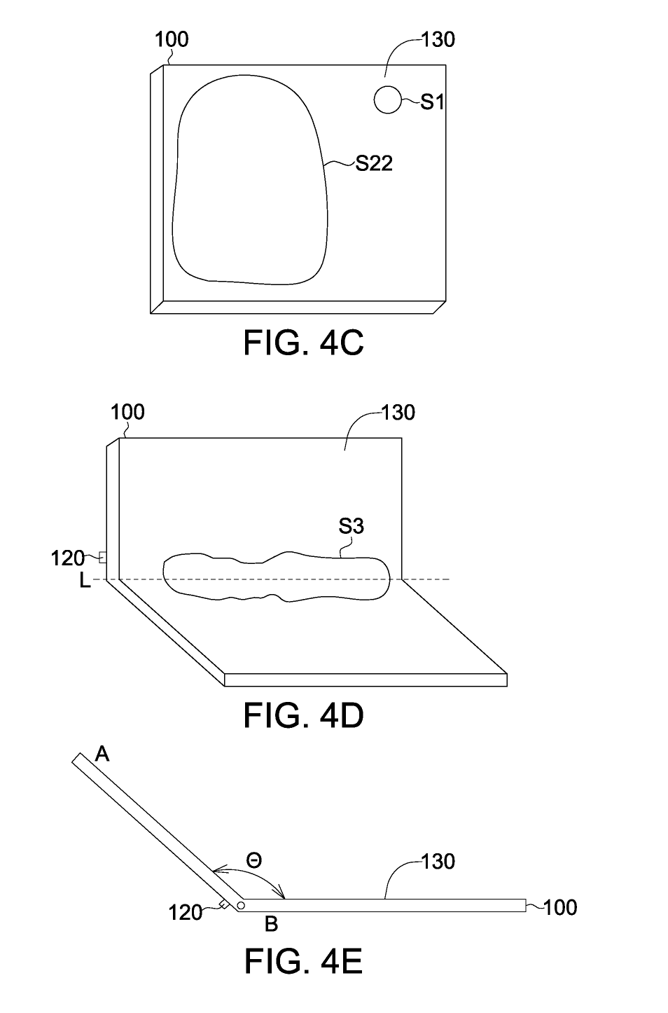

Firstly, referring to FIG. 1A and FIGS. 4A to 4E, FIGS. 4A to 4E are schematic diagrams of the changing of the physical characteristic of the touch module 100 according to the first embodiment. In this embodiment, touch panel 130 can be a foldable touch panel. In step S210, the storage unit 160 is used for providing an induction parameter of the touch panel 130. For example, the touch panel 130 can access the storage unit 160 to obtain a default induction parameter.

Next, in step S220, the sensing unit 110 receives an induction signal from the touch panel 130. The induction signal may be a touch signal inputted by user or a noise signal caused by bending the touch panel 130.

In step S230, the first determining unit 140 determines whether the induction signal is the touch signal. If the induction signal is not the touch signal, the process proceeds to step S240; if the induction is the touch signal, the process proceeds to the step S250.

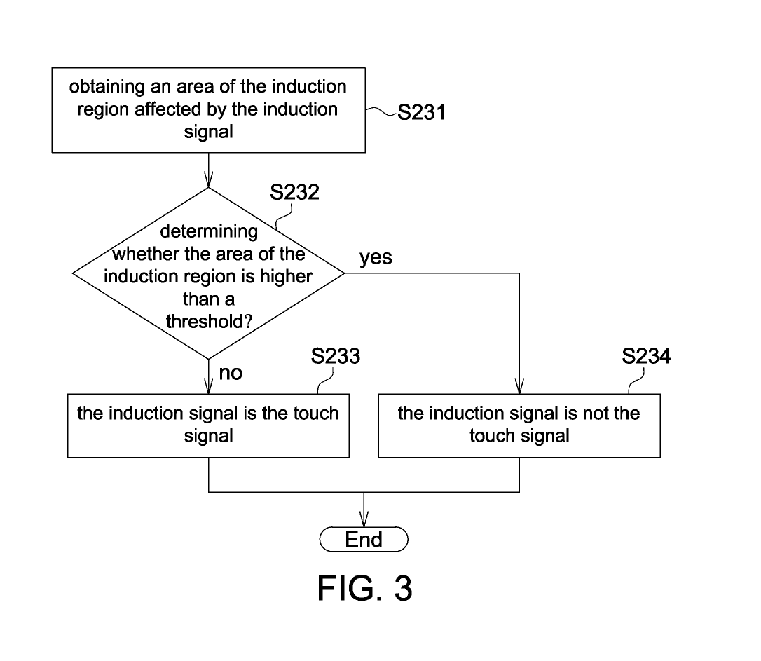

Besides, please referring to FIG. 3, FIG. 3 is a detailed flowchart of the step S230 according to the first embodiment. Step S230 includes steps S231 to S234. The following description describes steps S231 to S234.

In step S231, the first determining unit 140 obtains an area of an induction region 51 affected by the induction signal. And, the first determining unit 140 determines whether the area of the induction region 51 is higher than a threshold in step S232. If the area of the induction region 51 is higher than the threshold, it is determined that the induction signal is not the touch signal. If the area of the induction region 51 is not higher than the threshold, it is determined that the induction signal is the touch signal.

As shown in FIG. 4A, when the first determining unit 140 obtains the area of the induction region 51 affected by the induction signal, the first determining unit 140 determines whether the area of the induction region 51 is higher than the threshold. In this example, the induction region 51 is not higher than the threshold. Therefore, the process proceeds to step S233. In step S233, the first determining unit 140 determines that this induction signal is the touch signal and the process proceeds to step S250. In step S250, the point reporting unit 180 processes a touch point reporting procedure. In contrast, for instance, when the first determining unit 140 obtains an area of an induction region S2 affected by the induction signal, the first determining unit 140 determines the area of the induction region S2 is higher than the threshold and then the process proceeds to step S234. The induction region S2 may be caused by touching a large area, touching by palm or the physical characteristic of the touch panel 130 is changed. In step S234, the first determining unit 140 determines that this induction signal is not the touch signal and then the process proceeds to step S240.

Because the user usually uses finger or stylus to contact with the touch panel 130 for generating the touch signal, the area of the induction region will be small. On the contrary, the induction region whose area is big may be a noise caused by the bending parts of the touch panel 130. As shown in FIG. 4A, the induction region S2 whose area is big may be caused by bending the touch module 100 along a dotted line. Thus, the above steps can be used for determining whether the induction signal is the touch signal according to the area of induction region.

Next, in step S240, the second determining unit 150 determines whether a physical characteristic of the touch panel 130 is changed when the induction signal is not the touch signal. If the physical characteristic of the touch panel 130 is changed, the process proceeds to step S260. If the physical characteristic of the touch panel 130 is not changed, the process proceeds to step S250.

The changing of the physical characteristic of the touch panel 130 may be caused by a structural change of the touch panel (e.g. bending, folding), a temperature change of an environment, a humidity change of the environment, a pressure change of the environment, or an aging of the touch panel. As shown in FIG. 4B, the induction region S21 whose area is big is a humid region of the touch module 100 whose physical characteristic is changed due to humidity. As shown in FIG. 4C, the induction region S22 whose area is big is exposed to the sun, as such the physical characteristics changed due to the high temperate. Besides, as shown in FIG. 1B, the second determining unit 150 can be further connected to a physical characteristic sensor. For instance, the physical characteristic sensor is the bending sensor 120, a temperature sensor 123, a pressure sensor 125 or a counter 128 to detects the environment information or the service time and transmits the environment information to the second determining unit 150.

In this step, the second determining unit 150 determines whether the physical characteristic of the touch panel 130 is changed. For example, the second determining unit 150 determines whether the touch panel 130 is bent, if the physical characteristic of the touch panel 130 is changed, e.g. the touch panel 130 is bent, then the process proceeds to step S260. If the physical characteristic of the touch panel 130 is not changed, e.g. the touch panel 130 is not bent, then the process proceeds to step S250.

For another example, as shown in FIG. 4D, the touch module 100 is bent along the dotted line L. The side view of the touch module 100 in FIG. 4D is shown in FIG. 4E. An angle θ between a panel region A and a panel region B of the touch module 100 is shown. In this example, if the second determining unit 150 determines that the touch panel 130 is bent to cause the changing of the physical characteristic by the bending sensor 120, then the process is proceeds to step S260. In another embodiment, the second determining unit 150 can determine whether the touch panel 130 is bent according to the content of the induction signal which is detected by the sensing unit 110. By this way, the touch panel controlling system 1000 of the touch panel 130 does not need to configure the bending sensor 120

Through the steps S230 to S240 mentioned above, it is determined that the induction signal is not touch signal and the physical characteristic of touch panel 130 is changed. Thus, in step S260, the adjusting unit 170 adjusts the induction parameter of an induction region affected by the induction signal. As such, a new induction parameter is obtained. By this way, when the sensing unit 110 retrieves a new induction signal, the steps above mentioned can be performed repeatedly until the received induction signal is determined as the touch signal. Then, the point reporting unit 180 obtains the coordination of touching pint. In step S260, the adjusting unit 170 can adjust at least one of a scan frequency, a gain value, a driving voltage, an upper limit of an induce oscillation voltage, a lower limit of an induce oscillation voltage, an oscillation frequency, a charging current, a discharging current, a charging time, a discharging time, etc. or other parameter which have the same effect.

As shown in FIG. 4D, it is determined that the induction region S3 is not the touch signal and the physical characteristic of the touch panel 130 is changed by performing the steps S230 to S240. In step S260, the adjusting unit 170 further adjusts a scan frequency, a gain value, a driving voltage, an upper limit of an induce oscillation voltage, a lower limit of an induce oscillation voltage, an oscillation frequency, a charging current, a discharging current, a charging time, or a discharging time of the induction parameter of an induction region S3 affected by the induction signal, and then a new induction parameter can be obtained. By the steps described above, the touch panel 130 can use the first determining unit 140 to determine whether the induction signal is the touch signal according to the area of the received induction signal. And, the second determining unit 150 determines whether the physical characteristic is changed according to the content of the induction signal. If the induction signal is not the touch signal and the physical characteristic of the touch panel 130 is changed, the adjusting unit 170 further adjusts the induction parameter of an induction region affected by the induction signal. Therefore, the adjusting unit 170 can obtain a new induction parameter without adjusting the whole area of touch panel 130.

Through the steps described above, the induction parameter of the area whose the physical characteristic is changed (e.g. bending event) can be dynamically adjusted. As such, the induction parameter of this area whose the physical characteristic is changed and the induction parameter of this area whose the physical characteristic is not changed (e.g. unbending area) are identical. For example, after the touch panel 130 is bent many times, the structure of bending parts will cause variants even in the flat state. That is, after flatting the touch panel 130, the touch panel 130 is not flat. Besides, the electronic characteristic may be changed by the change of temperature or the change of the humidity when the touch panel 130 is in the flat state. In addition, the partial parts of the touch panel 130 have non-uniform physical phenomena caused by the manufacturing process. By the steps described above, the touch panel 130 can be avoided from generating the error signal caused by the change of physical characteristic. Therefore, the steps described above can improve the accuracy of the touch panel 130 while user operates it. In addition, if the steps mentioned above are processed repeatedly, the default induction parameter of the induction area can be adjusted and a new induction parameter can be obtained. Next, when the touch panel 130 receives a new induction signal by touching, the steps described above are performed repeatedly until the received induction signal is determined as the touch signal. Therefore, the accuracy of determining whether the received induction signal is the touch signal can be improved.

### Second Embodiment

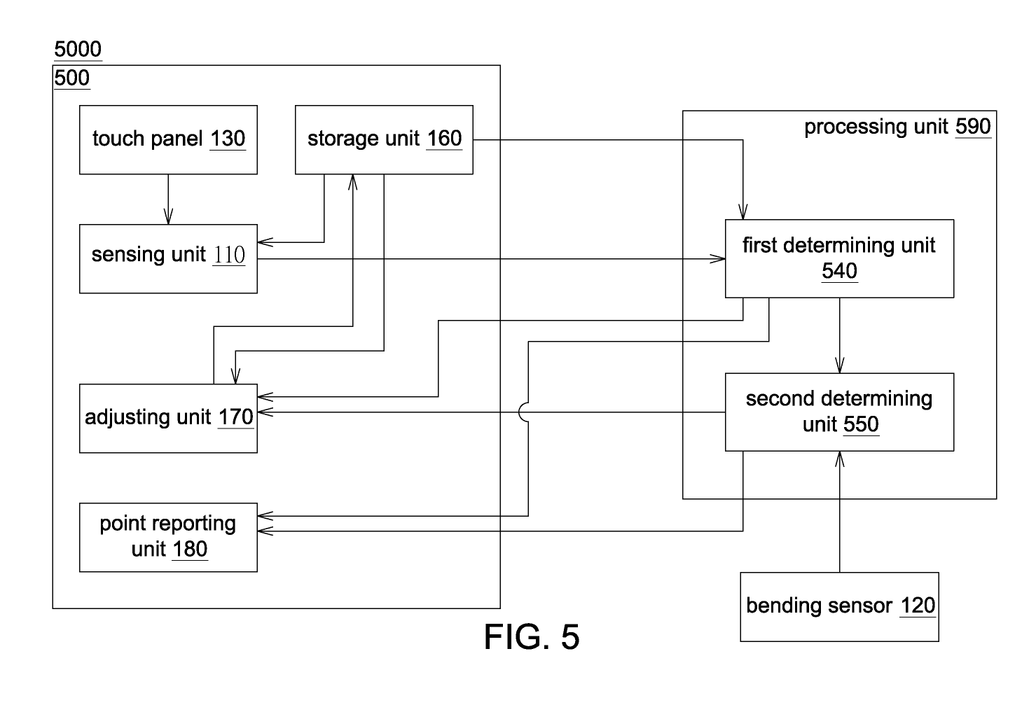

Referring to FIG. 5, FIG. 5 is a block diagram of a touch panel controlling system 5000 according to a second embodiment. The difference between the touch panel controlling system 5000 of this embodiment and the touch panel controlling system 1000 of the first embodiment is in the arrangement of components. In present embodiment, the first determining unit 540 and the second determining unit 550 are disposed in a processing unit 590 which is not disposed in the touch module 500. For example, the processing unit 590 can be a micro chip, a firmware circuitry or a storage device which stores a plurality of program codes. Besides, the touch module 500 includes the touch panel 130, the storage unit 160, the sensing unit 110, the adjusting unit 170 and point reporting unit 180.

The first determining unit 540 is connected to the second determining unit 550. The touch panel 130 is connected to the sensing unit110. The first determining unit 540 is connected to the storage unit 160, the sensing unit 110, the adjusting unit 170, the point reporting unit 180, and the second determining unit 550. The second determining unit 550 is connected to the adjusting unit 170 and the point reporting unit 180. The second determining unit 550 can be also connected to the bending sensor 120.

As shown in FIG. 5, the touch panel controlling system 5000 comprises a touch module 500, a bending sensor 120 and a processing unit 590.

The processing unit 590 further includes the first determining unit 540 and the second determining unit 550. The touch module 500 includes the touch panel 130, the sensing unit 110, the storage unit 160, the adjusting unit 170 and point reporting unit 180. When the touch panel 130 receives an induction signal whose data size is large, the induction signal can be transmitted to the processing unit 590. The processing unit 590 can help the touch module 500 to process the calculation.

Besides, the other technological features of components, steps and applications of the second embodiment are the same as those of the first embodiment, and detailed descriptions thereof will be omitted.

### Third Embodiment

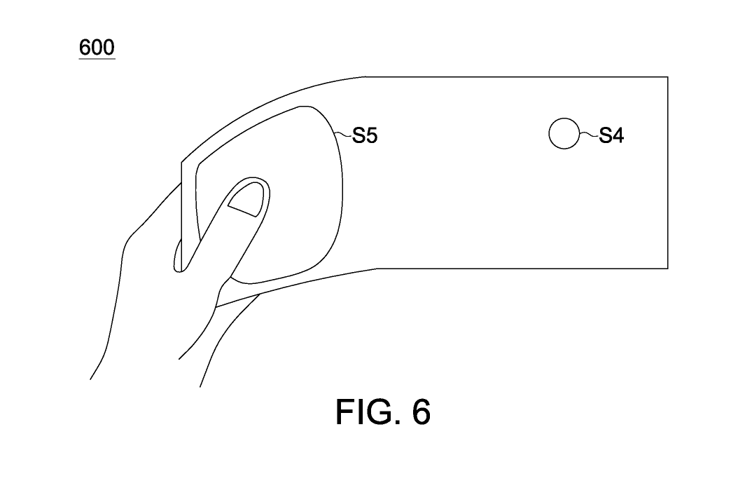

Referring to FIG. 6, FIG. 6 is a schematic diagram of a bending way of a touch panel according to a third embodiment. The different between this embodiment and the first embodiment is in that the touch module 600 of this embodiment is a flexible touch panel. The other technological features are the same as those of the first embodiment, and detailed descriptions thereof will be omitted.

As shown in FIG. 6, because the touch module 600 has flexibility, the touch module 600 is easy to be twisted by the hand, when the user holds the touch module 600. By performing the touch panel controlling method described in the first embodiment, the induction parameter of induction region S5 caused by error touching can be adjusted. It can avoid the error touching induction region S5 from impacting the signal detection of the induction region S4 which is the region that user wants to touch.

### Fourth Embodiment

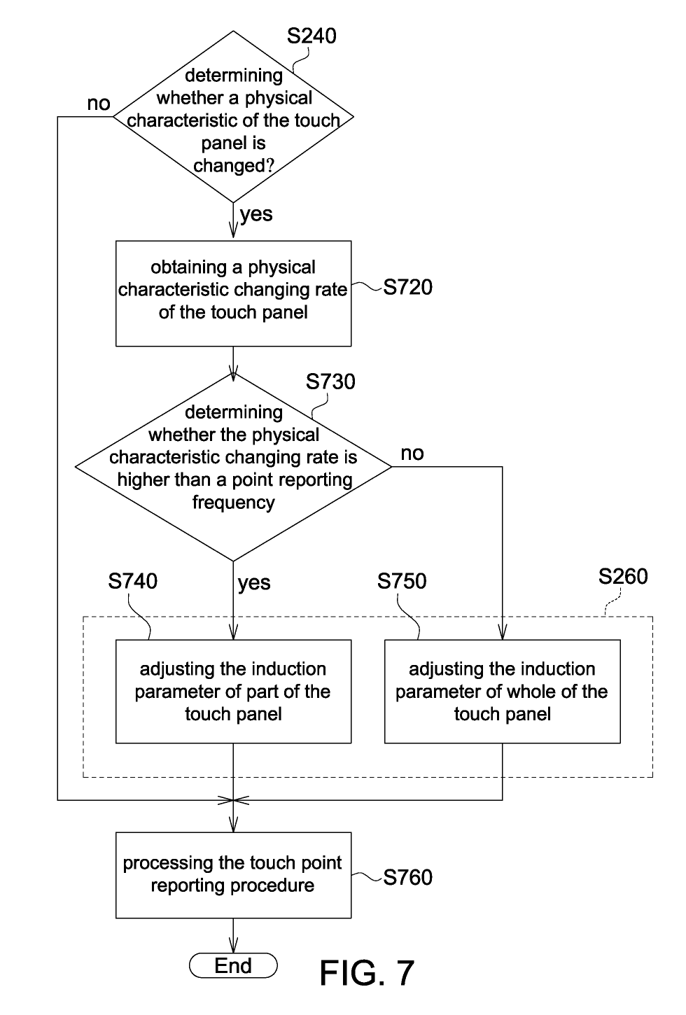

Please referring to FIG. 1A and FIG. 7, FIG. 7 is a flowchart diagram of a touch panel controlling method according to a fourth embodiment. The difference between this embodiment and the first embodiment is in that the touch panel controlling method of this embodiment further includes the steps of determining whether to adjust the induction parameter of whole of the touch panel 130 or only adjust the induction parameter of part of the touch panel 130 after performing the step S240.

In step S240, if the second determining unit 150 determines that the physical characteristic of touch panel 130 is changed, the process proceeds to step S720. If the second determining unit 150 determines that the physical characteristic of touch panel 130 is not changed, the process proceeds to step S760 to process the touch point reporting procedure.

In step S720, the second determining unit 150 further obtains a physical characteristic changing rate of touch panel 130. For example, the physical characteristic changing rate is a bending rate, a concave folding speed of touch panel, or concave folding times of touch panel. For example, the bending rate is the times of bending the touch panel 130 per unit time.

Next, in step S730, the second determining unit 150 determines whether the physical characteristic changing rate is higher than a point reporting frequency. If the physical characteristic changing rate is higher than the point reporting frequency, then the process proceeds to step S740. If the physical characteristic changing rate is not higher than the point reporting frequency, then the process proceeds to step S750. For instance, the second determining unit 150 determines whether the bending rate is higher than the point reporting frequency. The point reporting frequency is the times of point reporting of the point reporting unit 180 per unit time. If the bending rate is higher than the point reporting frequency, then the process proceeds to step S740 to adjust the induction parameter of part of the touch panel. And then, step S760 is performed to process the point reporting procedure.

On the other hand, if the physical characteristic changing rate is not higher than the point reporting frequency, for instance, the bending rate is not higher than the point reporting frequency, the process proceeds to the step S750 to adjust the induction parameter of whole of the touch panel. After the adjusting unit 170 performs adjusting the induction parameter of whole of the touch panel, the step S760 is performed to process the point reporting procedure.

For example, when the user reads the information displayed by the touch panel 130, and the user wants to search a specific page of the information by quickly open-closed the touch panel 130 to turn the pages. While the user quickly open-closed the touch panel 130 once, the system point reporting once. This will cause the frequency of point reporting can not keep up (or behind) the frequency of user quickly open-closed the touch panel 130. Thus, the bending rate of touch panel 130 is higher than point reporting frequency at the time. In this situation, the adjusting unit 170 only needs to adjust the induction parameter of part of the touch panel 130. For example, the system adjusts the page number part of display first to make the adjusted page number can be read normally by the user in the higher bending rate. In contrast, if user reads the words on each page carefully, the pages will be turned for a long time. In this situation, the bending rate is not higher than the point reporting frequency. Thus, the adjusting unit 170 can adjust the induction parameter of whole of touch panel 130 to give user the better reading quality.

Although the embodiments divided into the first embodiment to the fourth embodiment as example to explain. The first embodiment to the fourth embodiment can combine to at least one of each other on a same touch panel controlling system to cooperate the different conditions. For example, when the touch panel 130 is a flexible touch panel and the received data size of induction signal is huge, the system structure of the second embodiment can be use for improving the calculation efficiency and further combine the touch panel control method of the third embodiment to adjust the induction parameter of the concave folding parts of the touch panel. It can make the system achieves a better efficiency and avoids the error signal caused by the concave folding.

Therefore, the touch panel control method and a touch panel controlling system can instantly detect whether the induction signal is the touch signal and whether the panel has bending parts. It can further determine whether the touch panel has the error point reporting event caused by bending. Thus, the system does not need to adjust the principle of whole panel again. The system only needs to adjust the induction parameter of the bending part to achieve the effect of adjusting the touch panel.

While the disclosure has been described by way of example and in terms of the preferred embodiments, it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A touch panel controlling system, comprising:
a storage unit for storing an induction parameter of a touch panel;
a sensing unit for receiving an induction signal;
a first determining unit for determining whether the induction signal is a touch signal;
a second determining unit for determining whether a physical characteristic of the touch panel is changed if the induction signal is not the touch signal; and
an adjusting unit for adjusting the induction parameter of an induction region affected by the induction signal, if the physical characteristic of the touch panel is changed and the induction signal is not the touch signal.

2. The touch panel controlling system according to claim 1, further comprising:
a point reporting unit for performing a touch point reporting procedure if the induction signal is the touch signal.

3. The touch panel controlling system according to claim 1, further comprising:
a point reporting unit for performing a touch point reporting procedure if the induction signal is not the touch signal and the physical characteristic of the touch panel is not changed.

4. The touch panel controlling system according to claim 1, wherein the first determining unit is further used for obtaining an area of the induction region affected by the induction signal and determining whether the area of the induction region is higher than a threshold;
if the area of the induction region is higher than the threshold, it is determined that the induction signal is not the touch signal; and
if the area of the induction region is not higher than the threshold, it is determined that the induction signal is the touch signal.

5. The touch panel controlling system according to claim 1, wherein the second determining unit is further used for obtaining a physical characteristic changing rate and determining whether the physical characteristic changing rate is higher than a point reporting frequency;
if the physical characteristic changing rate is higher than the point reporting frequency, then the adjusting unit adjusts the induction parameter of part of the touch panel;
if the physical characteristic changing rate is not higher than the point reporting frequency, then the adjusting unit adjusts the induction parameter of whole of the touch panel.

6. The touch panel controlling system according to claim 1, wherein the second determining unit determines whether the physical characteristic of the touch panel is changed according to a content of the induction signal.

7. The touch panel controlling system according to claim 1, wherein the second determining unit determines whether the physical characteristic of the touch panel is changed by a bending sensor.

8. The touch panel controlling system according to claim 1, wherein the second determining unit determines whether the physical characteristic of the touch panel is changed by a physical characteristic sensor;
wherein the changing of the physical characteristic is caused by a structural change of the touch panel, a temperature change of an environment, a humidity change of the environment, a pressure change of the environment, or an aging of the touch panel.

9. The touch panel controlling system according to claim 1, wherein the adjusting unit adjusts a scan frequency, a gain value, a driving voltage, an upper limit of an induce oscillation voltage, a lower limit of the induce oscillation voltage, an oscillation frequency, a charging current, a discharging current, a charging time or a discharging time.

10. The touch panel controlling system according to claim 1, wherein the touch panel is connected to the sensing unit; the first determining unit is connected to the second determining unit, the sensing unit, the adjusting unit and the point reporting unit; the second determining unit is connected to the adjusting unit, the point reporting unit and a bending sensor; the storage unit is connected to the adjusting unit.

11. The touch panel controlling system according to claim 1, wherein the first determining unit and the second determining unit are configured in a processing unit; the first determining unit is connected to the second determining unit; the touch panel, the storage unit, the sensing unit, the adjusting unit and the point reporting unit are configured in a touch module; the touch panel is connected to the sensing unit; the first determining unit is connected to the storage unit, the sensing unit, the adjusting unit, the point reporting unit, and the second determining unit; the second determining unit is connected to the adjusting unit, the point reporting unit and a bending sensor.

12. A touch panel controlling method, comprising the steps of:
providing an induction parameter of a touch panel;
receiving an induction signal by a sensing unit;
determining whether the induction signal is a touch signal;
determining whether a physical characteristic of the touch panel is changed, if the induction signal is not the touch signal; and
adjusting the induction parameter of an induction region affected by the induction signal, if the physical characteristic of the touch panel is changed.

13. The touch panel controlling method according to claim 12, comprising:
performing a touch point reporting procedure, if the induction signal is the touch signal.

14. The touch panel controlling method according to claim 12, wherein if the induction signal is not the touch signal and the physical characteristic of the touch panel is not changed, a touch point reporting procedure is performed.

15. The touch panel controlling method according to claim 13, wherein the step of determining whether the induction signal is the touch signal comprises:
obtaining an area of the induction region affected by the induction signal; and
determining whether the area of the induction region is higher than a threshold;
wherein if the area of the induction region is higher than the threshold, it is determined that the induction signal is not the touch signal;
if the area of the induction region is not higher than the threshold, it is determined that the induction signal is the touch signal.

16. The touch panel controlling method according to claim 12, wherein after the step of determining whether the physical characteristic of the touch panel is changed, the touch panel controlling method further comprises:
obtaining a physical characteristic changing rate; and
determining whether the physical characteristic changing rate is higher than a point reporting frequency;
wherein if the physical characteristic changing rate is higher than the point reporting frequency, then in the step of adjusting the induction parameter of the induction region, the induction parameter of part of the touch panel is adjusted;
if the physical characteristic changing rate is not higher than the point reporting frequency, then in the step of adjusting the induction parameter of the induction region, the induction parameter of whole of the touch panel is adjusted.

17. The touch panel controlling method according to claim 12, wherein in the step of determining whether the physical characteristic of the touch panel is changed, whether the physical characteristic of the touch panel is changed is determined according to the induction signal.

18. The touch panel controlling method according to claim 12, wherein in the step of determining whether the physical characteristic of the touch panel is changed, whether the physical characteristic of the touch panel is changed is determined by a physical characteristic sensor.

19. The touch panel controlling method according to claim 18, wherein the physical characteristic sensor is a bending sensor used for determining whether the touch panel is bent, and the bending of the touch panel causes the change of the physical characteristic of the touch panel;
wherein the changing of the physical characteristic is caused by a structural change of the touch panel, a temperature change of an environment, a humidity change of the environment, a pressure change of the environment, or an aging of the touch panel.

20. The touch panel controlling method according to claim 12, wherein in the step of adjusting the induction parameter of the induction region, a scan frequency, a gain value, a driving voltage, an upper limit of an induce oscillation voltage, a lower limit of the induce oscillation voltage, an oscillation frequency, a charging current, a discharging current, a charging time or a discharging time is adjusted.
